(19) United States
(12) Patent Application Publication
(10) Pub. No.: US 2010/0211612 A1
(43) Pub. Date: Aug. 19, 2010

(54) UTILIZATION OF RADIO STATION METADATA TO CONTROL PLAYBACK OF CONTENT AND DISPLAY OF CORRESPONDING CONTENT INFORMATION

(76) Inventor: Mohammad Afaneh, Noblesville, IN (US)

Correspondence Address: F. CHAU & ASSOCIATES, LLC, 130 WOODBURY ROAD, WOODBURY, NY, 11797, US

(21) Appl. No.: 12/388,100

(22) Filed: Feb. 18, 2009

(51) Int. Cl. G06F 17/30; G06F 3/00

(52) U.S. Cl. 707/803; 715/704; 707/E17.143

(57) ABSTRACT

A system for recording and playing back a data stream includes an internet radio receiver, a decoder, a recorder, and a player. The internet radio receiver is configured to receive a data stream of internet radio. The decoder is configured to decode the data stream into an audio stream and a metadata stream. The recorder is configured to store audio of the audio stream into an audio file and store metadata from the metadata stream that correspond to a plurality of segments of the audio stream and corresponding reception times of each segment into subsequent data rows of a metadata file. The player is configured to play the audio file and display the metadata for a data row of the metadata file when an elapsed time matches the reception time of the data row.

### BACKGROUND OF THE INVENTION

1. Technical Field

The present disclosure relates to recording and playback of a data stream, and more particularly to systems and methods for recording audio of a data stream and playing back the audio and corresponding content information using metadata.

2. Discussion of Related Art

Internet radio is the transmission of audio programs to one or more recipients via the Internet. There are many different types of Internet radio stations in operation today. Some Internet radio stations are simply simulcasts of traditional radio stations. However, other Internet radio stations are completely independent from traditional radio stations and broadcast only on the Internet. Because of the increase in Internet connection speeds and the decrease in connection costs, the popularity of Internet radio is likely to continue to increase.

There are many components that are involved in the creation of an Internet radio station. Initially, a program signal for the Internet radio station is generated. The program signal includes the content of the Internet radio station. Once the program signal has been generated, encoding tools are used to encode the program signal into a data stream. A server exposes the data stream to clients, which may connect to the server and receive the data stream.

The data stream typically includes an audio stream and a metadata stream (e.g., artist name, track title, genre, etc.) The metadata stream may also include the station name and the elapsed time since streaming started.

One conventional method of recording the data stream, records only the audio stream into a single recording file, while all of the metadata is discarded. For example, if the audio stream includes multiple songs, the resulting recorded file includes all of the songs. However, since the metadata has been discarded, content information about the individual songs cannot be presented to the user while the recording file is played back.

In another conventional recording method, the songs in a data stream are decoded into separate files, where each file includes metadata for the single song. For example, an MPEG-1 Audio Layer 3 (MP3) file stores a single song and includes an ID3 tag to store metadata for the song. If the data stream includes several songs, the data stream can be split into several MP3 files. Each individual MP3 file can then be played back, and the ID3 tag can be used to display the corresponding content information. However, this approach requires that multiple song files be maintained and managed, and also results in a loss of chronological information regarding the time ordering of the songs.

Thus, there is a need for systems and methods for recording and playing back a data stream that provide content information to a user during the playback, but which do not require the audio of the data stream to be stored as multiple files.

### SUMMARY OF THE INVENTION

An exemplary embodiment of the present invention includes a method of recording a data stream. The method includes storing audio of the data stream into an audio file and storing metadata of the data stream for a current segment of the audio and a timestamp at which the metadata is received, into a data row of a metadata file. Each data row corresponds to a unique segment of the audio.

The metadata file may be an editable text file. The method may further comprise editing a data row of the metadata file to correct an error. The storing of the audio and the metadata may comprise decoding the data stream into an audio stream and a metadata stream, and extracting the audio from the audio stream and the metadata from the metadata stream.

The data stream may be transmitted from an internet radio station or a radio data system (RDS). The audio file and the metadata file may include a part of same file name that enables the audio file to be linked to the metadata file. For example, the audio file and the metadata file may differ only in their file extension. The audio file may be an MPEG-1 Audio Layer 3 (MP3), a RealAudio (RA), a Windows Media Audio (WMA), etc.

An exemplary embodiment of the present invention includes a method of playing back a recorded data stream. The method includes selecting an audio file for playback, identifying a corresponding metadata file based on the selected audio file, playing the audio file, and displaying a part of metadata for a selected data row in the metadata file. The metadata file includes a plurality of data rows, each data row including metadata and a timestamp for a unique segment of the audio file.

The data row may be selected when its timestamp matches the elapsed time since the playback began. The method may further include receiving selection information from a user indicating the selected data row before the playing of the audio file and the displaying of the metadata. The playing of the audio file may further comprise advancing the audio file based on the timestamp of the selected row.

An exemplary embodiment of the present invention includes a system for recording and playing back a data stream. The system includes an internet radio receiver, a decoder, a recorder, and a player. The internet radio receiver is configured to receive a data stream of internet radio. The decoder is configured to decode the data stream into an audio stream and a metadata stream. The recorder is configured to store the audio stream into an audio file and store metadata from the metadata stream that correspond to a plurality of segments of the audio stream and corresponding reception times of each segment into subsequent data rows of a metadata file. The player is configured to play the audio file and display the metadata for a data row of the metadata file when an elapsed time matches the reception time of the data row.

The system may further include a frequency modulation (FM) radio receiver to receive radio broadcasts, a second decoder to decode the radio broadcasts in a radio data system (RDS) format to extract an audio signal and corresponding digital information, and an encoder to encode the audio signal into an audio file.

The system may further include an internet radio tuner to select a particular internet radio channel and/or an FM radio tuner to select a particular FM radio channel. The system may further comprise a storage device configured to store the audio file and the metadata file. The storage device may include a buffer that is used by the recorder to temporarily buffer the metadata while the audio stream is recorded. The buffer may be shared by the player for reading in of the stored metadata when the recorded audio stream is played back.

### BRIEF DESCRIPTION OF THE DRAWINGS

Exemplary embodiments of the invention can be understood in more detail from the following descriptions taken in conjunction with the accompanying drawings in which:

FIG. 1 illustrates a method of recording a data stream, according to an exemplary embodiment of the present invention;

FIG. 2 illustrates an exemplary metadata file that may be generated from the method of FIG. 1;

FIG. 3 illustrates a method of playing back a data stream using the metadata file of FIG. 2, according to an exemplary embodiment of the present invention;

FIG. 4 illustrates an exemplary interface for playing back a recorded data stream;

FIG. 5 illustrates a system to record and playback a data stream, according to an exemplary embodiment of the present invention.

### DETAILED DESCRIPTION OF THE EXEMPLARY EMBODIMENTS

Exemplary embodiments of the present invention will be described below in more detail with reference to the accompanying drawings. This invention may, however, be embodied in different forms and should not be construed as limited to the embodiments set forth herein.

It is to be understood that the present invention may be implemented in various forms of hardware, software, firmware, special purpose processors, or a combination thereof. The present invention may be implemented as a combination of both hardware and software, the software being an application program tangibly embodied on a program storage device. The application program may be uploaded to, and executed by, a machine comprising any suitable architecture. The machine may be implemented on a computer platform having hardware such as one or more central processing units (CPU), a random access memory (RAM), and input/output (I/O) interface(s). The computer platform may also include an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device.

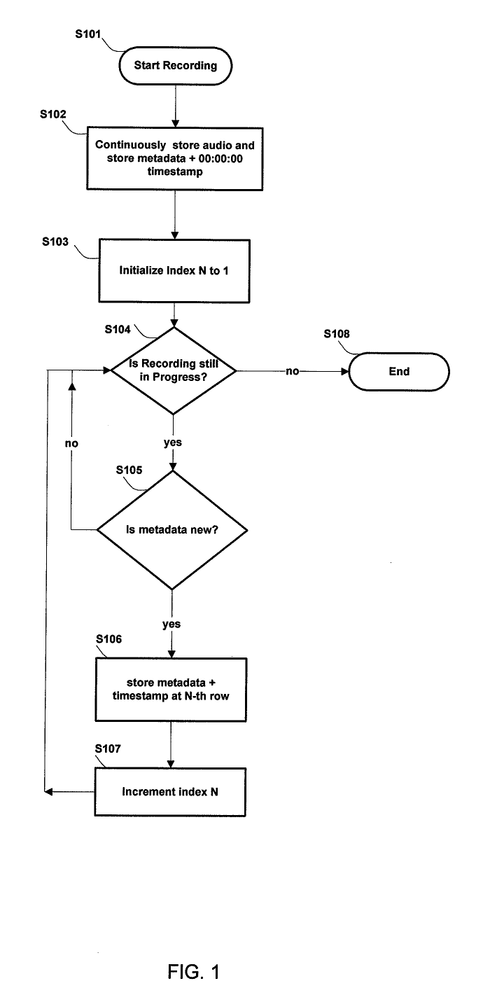

FIG. 1 illustrates a method of recording a data stream, according to an exemplary embodiment of the present invention. A graphical user interface may be provided to enable a user to begin the recording of a particular data stream (S101). The data stream may be provided from an internet radio station. The data stream may be sent according to various streaming protocols such as RealAudio (RA), MP3, Windows Media Audio (WMA), etc. The data stream includes a metadata stream and an audio stream. The information in the metadata stream may be formatted according to the streaming protocol.

Referring to FIG. 1, the audio stream is continuously stored into an audio file or an audio buffer and the current metadata and a starting timestamp (e.g., 00:00:00) are stored at a first data row (e.g., 0^{th} row) in the metadata file or a metadata buffer. An index N that corresponds to data rows of the metadata file/buffer is set to point to the next data row (e.g., N=1 for the 2^{nd} data row) (S103). Since the user can stop the recording at any time, a determination is made as to whether the recording is still in progress (S104). If the recording is still in progress, then it is determined whether current metadata of the metadata stream is new (S105). For example, metadata of existing rows of the metadata file/buffer may be compared against current metadata in the metadata stream to determine if the current metadata is new. If the metadata is new, this new metadata and a current timestamp are stored at the N-th row in the metadata file/buffer (S106). The current timestamp may be output by a timer that was started when the starting timestamp was stored. The timer may advance by seconds to keep track of the time that has elapsed since the recording started. The index N is then incremented (S107) and the method resumes back to determining whether the recording is still in progress (S104). If it was determined that the metadata was not new, the method resumes back to determining whether the recording is still in progress (S104). If the recording is no longer in progress, the method terminates (S108).

If the audio buffer and metadata buffer were used, the audio buffer is written to the audio file and the metadata buffer is written to the metadata file before the method terminates.

Alternately a single buffer may be used to store the metadata information while recording the audio (and before finalizing the recording process), and for reading the metadata information from the metadata file at the time of playback. Recording and playback operations could then use the same buffer to reduce the amount of memory used (since both operations need not happen at the same time). The actual buffering may be used to improve performance speed and to avoid extra file writing (of the metadata info) while recording the audio.

The audio file may one of a variety of audio file formats, such as MP3, WMA, RA, etc. The metadata file may be a text file. The audio file and metadata file may be named so that they can be easily correlated with one another. For example, the audio file and the corresponding metadata file may be named such that they only differ by extension (e.g., station.mp3 and station.meta).

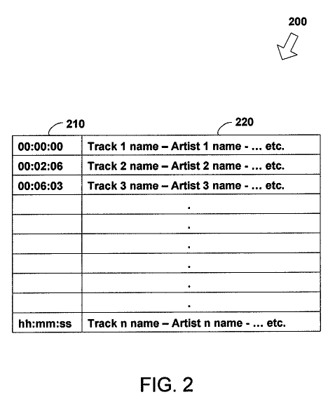

FIG. 2 illustrates an example of the metadata file that may be generated using the method of FIG. 1. The metadata file 200 includes a time stamp column 210 and a metadata column 220. Each data row corresponds to a different song in the data stream. Each data row of the time stamp column 210 is a respective start time of a corresponding song. Each row of the metadata column 220 is metadata of the corresponding song. For example, the metadata may include a title, artist name, album name, a year, a comment, a track number, a genre, a start time, an end time, etc. However, the present invention is not limited to data streams that include multiple songs. The data streams may includes episodes of television program, segments of a talk show, chapters of an audio book, etc. Accordingly, the metadata would include different content information such as episode name, segment names, chapter names, etc.

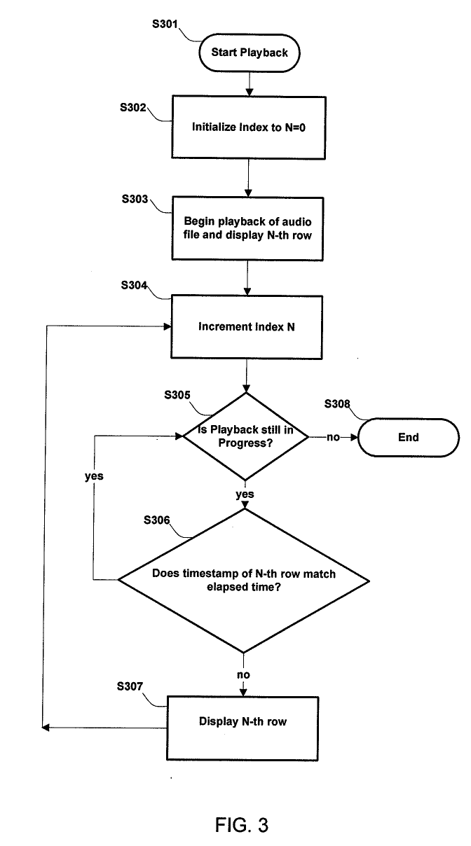

FIG. 3 illustrates a method of playing back a data stream using the metadata file of FIG. 2, according to an exemplary embodiment of the present invention. A graphical user interface may be provided to enable a user to begin the playback of a recorded data stream (S301). When playback of the recorded data stream is initiated, the audio file and corresponding metadata file are opened and may each be read into temporary buffers. An index N is set to point to the first data row of the metadata file (e.g., N is set to 0) (S302). The index N may be saved in memory. The audio file is then played while the N-th row of the metadata file is displayed (S303). The index N is then incremented (S304). Since the user can stop the playback at any time, a check is performed to determine whether the playback is still in progress (S305). If the playback is still in progress, it is determined whether the timestamp of the N-th row in the metadata file matches the current elapsed time of the playback (S306). The current elapsed time may be output by a timer that was started when the audio file began playing back. The N-th row of the metadata file is displayed if the timestamp matches the current elapsed time (S307). The method then resumes back to the step of incrementing the index N (S304). The method resumes to the step of determining whether playback is still in progress (S306) when the timestamp of the N-th row does not match the current elapsed time. The method terminates when it is determined that the playback is no longer in progress (S308).

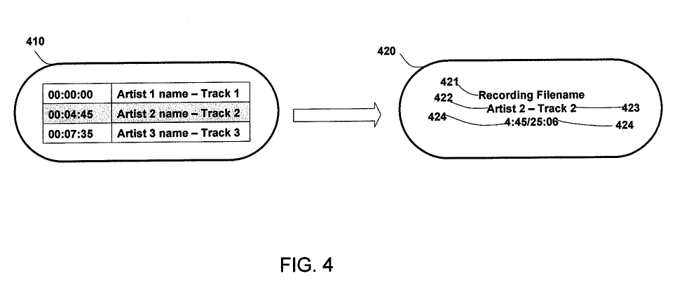

The method of FIG. 3 illustrates a sequential playback of a recorded audio file from start to end. However, the method can be modified to begin playback of the audio file at a different time point in the file. For example, instead of initializing the index N to 0 in step 302, the counter N can be set to a row index value selected by a user. Further, instead of starting the playback of the audio file at the beginning in step 303, the playback can be begun at the timestamp of the N-th data row in the metadata file. For example, FIG. 4 illustrates a first window 410 with selectable rows. The user can select a particular row to begin playback of the audio file at the selected point in the audio file. This enables a user to skip a non-desired track/program and instantly seek to a desired track/program within a long recording. The first window 410 includes portions of the metadata that can be used to identify different segments in the audio file. A second window 420 can be presented to display more detailed information about a currently played back audio segment. In one example, the second window 420 displays the name of the audio file 421, the artist name 422 of the currently played audio segment, the track number 423 of the currently played audio segment, the elapsed time of the playback 424, and the duration of the audio file 425.

Referring back to FIG. 2, the metadata file 200 may be configured such that it is editable by a user. This gives the user the flexibility to modify timestamps of the recording's metadata when errors from the source occur. For example, if a station sends the track metadata earlier/later than it should be sent, then the user can modify the timestamp to accommodate for that error. Compared to conventional recording systems, the same solution is not available because the recording would have already been split into separate files. Further, a user can modify the corresponding metadata of each row, add additional data rows, or delete existing data rows. The buffers used in recording may be shared by the player to save memory.

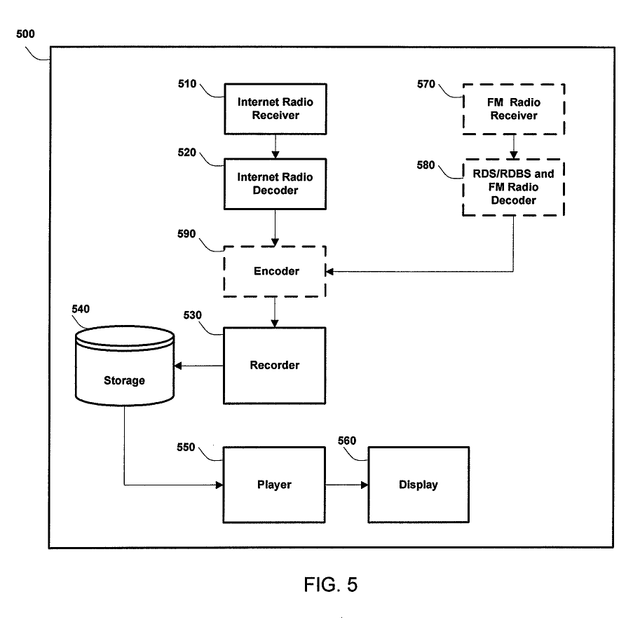

FIG. 5 illustrates a system 500 that is configured to record and playback a data stream, according to an exemplary embodiment of the present invention. Referring to FIG. 5, the system 500 includes an internet radio receiver 510, an internet radio decoder 520, a recorder 530, storage 540, a player 550, and a display 560.

The internet radio receiver 510 may receive a data stream from internet radio over an input wire or wirelessly. The internet radio decoder 520 decodes the data stream to extract the audio and the metadata. The audio may already be in a suitable format for recording. However, if the format is not suitable, the system 500 may additionally include an encoder 590 to encode the audio into a suitable format (e.g. MP3, WMA, RA, etc).

The recorder 530 may be configured to use the above described recording methods to record a portion of the data stream. For example, the recorder 530 can store the audio in an audio buffer/file and the metadata in a metadata buffer/file in storage 540.

The player 550 is configured to retrieve data from the audio buffer/file and the metadata buffer/file from storage 540 and playback the recorded data stream using the above described playback methods.

The display 560 can be used to present a graphical interface to a user to start the recording, playback the recording, present content information during the playback, and edit the metadata file.

Radio data system (RDS) is a communications protocol standard from the European Broadcasting Union for sending small amounts of digital information using conventional FM radio broadcasts. The RDS system standardizes several types of information transmitted, including time, track/artist info and station identification. Radio broadcast data system (RDBS) is the official name used for the U.S. version of RDS. The two standards are nearly identical, with only slight differences, mainly in which numbers are assigned to each of 31 musical and other program formats the RBDS system can identify. The system 500 may alternately or additionally support processing of data from an RDS or an RDBS.

For example, the system 500 may include a FM Radio Receiver 570, an RDS/RDBS and FM Radio Decoder 580. The Receiver 570 is configured to receive FM radio broadcasts that are output by an RDS/RDBS. The Decoder 580 is configured to decode the FM broadcast to extract an audio signal and corresponding digital information. The Encoder 590 can covert the audio signal into an audio file of a suitable format. For example, the encoder may encode the audio signal into one of the above described audio file formats. The digital information corresponding to the audio signal can be treated like metadata and stored along with the audio file by the recorder 530 in storage 540 according to the above described recording method. The player 550 can then playback the broadcast according to the above described playback methods.

The system may additionally include an internet radio and/or FM radio tuner to select a particular internet radio channel or FM radio channel for recording. The system 500 may be configured to simultaneously record multiple internet radio channels and/or FM channels.

The above described embodiments give a user the flexibility to playback a recording as a single file instead of multiple files, which each have to be maintained separately. This preserves the chronological order of the recording entities, which may be especially useful in the recording of talk shows. Further, at least one of the above described embodiments gives a user an option to skip to different tracks/programs within a single recording.

Although the illustrative embodiments have been described herein with reference to the accompanying drawings, it is to be understood that the present invention is not limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. A method of recording a data stream, the method comprising:
storing audio of the data stream into an audio file; and
storing metadata of the data stream for a current segment of the audio and a timestamp of a time at which the metadata is received into a data row of a metadata file, where each data row corresponds to a unique segment of the audio.

2. The method of claim 1, wherein the metadata file is an editable text file.

3. The method of claim 2, further comprising editing a data row of the metadata file to correct an error.

4. The method of claim 1, wherein the storing of the audio and the metadata comprise:
decoding the data stream into an audio stream and a metadata stream; and
extracting the audio from the audio stream and the metadata from the metadata stream.

5. The method of claim 1, wherein the data stream is transmitted from an internet radio station or a radio data system (RDS).

6. The method of claim 1, wherein the audio file and the metadata file include a part of same file name that enables the audio file to be linked to the metadata file.

7. The method of claim 1, wherein the audio file is one of a MPEG-1 Audio Layer 3 (MP3), RealAudio (RA), or a Windows Media Audio (WMA) file.

8. A method of playing back a recorded data stream, the method comprising:
selecting an audio file for playback;
identifying a corresponding metadata file based on the selected audio file, wherein the metadata file includes a plurality of data rows, each data row including metadata and a timestamp for a unique segment of the audio file;
playing the audio file; and
displaying a part of the metadata for a selected data row in the metadata file.

9. The method of claim 8, wherein the data row is selected when its time stamp matches an elapsed time since the playback began.

10. The method of claim 8, further comprising:
receiving selection information from a user indicating the selected data row before the playing of the audio file and the displaying of the metadata,
wherein the playing of the audio file comprises advancing the audio file based on the timestamp of the selected row.

11. The method of claim 8, wherein the recorded data stream is transmitted from an internet radio station or a radio data system (RDS).

12. The method of claim 8, wherein the audio file and the metadata file include a part of a same filename that enables the audio file to be linked with the metadata file.

13. The method of claim 8, wherein the audio file is one of a MPEG-1 Audio Layer 3 (MP3), RealAudio (RA), or a Windows Media Audio (WMA) file.

14. A system for recording and playing back a data stream, the system comprising:
an internet radio receiver configured to receive a data stream of internet radio;
a decoder configured to decode the data stream into an audio stream and a metadata stream;
a recorder configured to store audio of the audio stream into an audio file and store metadata from the metadata stream that correspond to a plurality of segments of the audio stream and corresponding reception times of each segment into subsequent data rows of a metadata file; and
a player configured to play the audio file and display the metadata for a data row of the metadata file when an elapsed time matches the reception time of the data row.

15. The system of claim 14, further comprising:
a frequency modulation (FM) radio receiver configured to receive radio broadcasts;
a second decoder configured to decode the radio broadcasts in a radio data system (RDS) format to extract an audio signal and corresponding digital information; and
an encoder configured to encode the audio signal into an audio file.

16. The system of claim 14, further comprising an internet radio tuner to select a particular internet radio channel.

17. The system of claim 15, further comprising an FM radio tuner to select a particular FM radio channel.

18. The system of claim 14, further comprising a storage device configured to store the audio file and the metadata file.

19. The system of claim 14, wherein the storage device includes a buffer that is used by the recorder to temporarily buffer the meta data while the audio stream is recorded.

20. The system of claim 14, wherein the buffer is shared by the player for reading in of the stored metadata when the recorded audio stream is played back.
